(19) United States
(12) Patent Application Publication
(10) Pub. No.: US 2010/0297414 A1
(43) Pub. Date: Nov. 25, 2010

(54) COMPOSITE SHEET BASED ON HIGH PRESSURE LAMINATE SHEETS (HPL SHEETS)

(75) Inventors: Karl-Ludwig Brentrup, Moriken (CH); Uwe Rothenberger, Wittstock/Dosse (DE); Nicola Adamo, Milano (IT); Chiara Zaniboni, Zurich (CH)

Correspondence Address: BROOKS KUSHMAN P.C., 1000 TOWN CENTER, TWENTY-SECOND FLOOR, SOUTHFIELD, MI, 48075, US

(73) Assignee: QUADRANT PLASTIC COMPOSITES AG, Lenzburg (CH)

(21) Appl. No.: 12/677,568

(22) PCT Filed: Sep. 11, 2008
(86) PCT No.: PCT/EP2008/007461

§ 371 Date: Jul. 19, 2010

(30) Foreign Application Priority Data
Sep. 11, 2007 (EP) 07017729.0

(51) Int. Cl. B32B 7/02; B32B 7/12; B32B 3/26; B32B 37/12

(52) U.S. Cl. 428/215; 428/317.1; 428/317.5; 428/317.7; 156/60

(57) ABSTRACT

A composite sheet has cover layers of high pressure laminate sheets A and a core layer B arranged therebetween. The core layer is formed for an air pore-containing, fiber reinforced thermoplastic and is adhesively bonded to the cover layers by an anhydrous adhesive which is mechanically anchored in surface pores of the core layer B.

### TECHNICAL FIELD

The invention relates to a composite sheet based on high-pressure laminate sheets (HPL sheets), comprising two cover layers A and a core layer B arranged therebetween. Furthermore, the invention comprises a method for producing such a composite sheet and applications thereof.

### PRIOR ART

Decorative high-pressure laminate sheets, so-called HPL sheets (“High Pressure Laminates”) have been known for a long time; they are standardized according to DIN EN 438 and ISO 4586. They are distributed e.g. as RESOPAL laminate HPL sheets. These are actually multi-layer sheets consisting of sheets of fibrous cellulose that are impregnated-with thermoset resins, in-particular with phenolic resin, and that have a surface coating made of decor paper soaked with melamine resin. The simultaneous application of heat (above 120° C.) and high pressure (above 5 MPa) allows for flowing and subsequent hardening of the thermoset resins, whereby a homogeneous and nonporous material with a raw density of more than 1.4 g/cm³ and with a smooth surface is obtained. For the surface coating, one can use printed papers, metal foils, veneer, textiles or imitations thereof in order to achieve particular aesthetic effects. The HPL laminate sheets are used e.g. for floorings, furniture parts and, in particular, for kitchen work-plates. They do not melt, are heat and light resistant, waterproof and also shock and abrasion-resistant. In order to achieve sufficient stability and self-supporting dimension-stable properties, they should have a thickness of at least 5 mm. However, this makes them relatively heavy.

WO 2006/071463 A2 describes, among others, a sandwich sheet with a core layer made of dehydrated reinforcing fibers and organic fibers, which core layer optionally can contain air pores and is arranged between two cover layers. As examples for cover layers there are mentioned glass mat reinforced polypropylene, metal or plastic foils. The sheets can be used for acoustic and thermal insulation.

WO 2005/097879 A2 and the corresponding U.S. 2005/0215698A1 describe a composite sheet with a pore-containing core layer made of thermoplasts and reinforcing fibers, as well as cover layers which can consist, among others, of high temperature-resistant thermoplast foils, metal foils, thermally hardening coatings or fibrous structures, and which have a “limiting oxygen index” LOI according to ISO 4589 of at least 22. The cover layers shall enhance the fire and temperature resistance and the burnt gas density of the core layer. The composite sheets are mainly used in aircraft industry, but also in building structures.

GB 2 428 992 A (Translator's Note: should be GB 2 428 993 A) describes a composite panel, particularly for coating the wall surrounding a bath roam shower, with a baseplate of closed-cell foam polystyrene with a thickness of 9 mm and a HPL cover layer with a thickness of 1.2 mm adhesively bonded thereto. These materials are selected in such a way that the panel is waterproof and as lightweight as possible, whereas an improved flexural rigidity is not required considering the wall fastening. A mechanical anchoring of the adhesive in the pores of the core layer surface is not possible with a closed-cell foam.

### DESCRIPTION OF THE INVENTION

It is an object of the invention to provide lighter and flexurally more rigid composite sheets based on HPL laminate sheets.

This object is achieved according to the present invention by means of a composite sheet based on high-pressure laminate sheets (HPL sheets), the composite sheet comprising two cover layers A and a core layer B arranged therebetween, wherein each cover layer A is formed of a HPL sheet and wherein the core layer B and the cover layers A are bonded to each other by an adhesive. The core layer B is made of a fiber reinforced thermoplastic with a content of reinforcing fibers of 35 to 80 wt-% and a content of air pores of 20 to 85 vol-%, and the adhesive is mechanically anchored in the pores present at the surface of the core layer.

The cover layers A are the basically known high-pressure laminate sheets (HPL sheets) that have been described in detail hereinabove. In particular, these HPL sheets are made of a plurality of cellulose fiber tissue sheets that are stacked on each other and are impregnated with a resin, the HPL sheets having a density of at least 1.4 g/cm³. They have preferably a thickness of 0.5 to 2.0 mm, particularly 0.8 to 1.2 mm.

The core layer B is made of a fiber reinforced thermoplastic with a content of reinforcing fibers of 35 to 80 wt-%, preferably of 40 to 70 wt-%. The reinforcing fibers are preferably nondirectional and needled. It is essential that the core layer contain air pores, namely 20 to 85 vol-%, preferably 25 to 75 vol-%. The core layer in the finished composite material has a thickness of preferably 1 to 10 mm, particularly 2 to 8 mm. Semifinished product sheets to be used as the core layer can be produced, e.g., by dry blending of thermoplast fibers and reinforcing fibers, needling of the blended nonwoven thus obtained, heating to temperatures above the softening point of the thermoplast and compressing.

Useful thermoplasts comprise all the spinnable thermoplasts, e.g. polyolefins such as polyethylene and polypropylene, polyamides, linear polyesters, thermoplastic polyurethanes, polycarbonate, polyacetals, and corresponding copolymers and thermoplast blends, but also high temperature resistant polymers such as polyarylates, polysulfones, polyimides, polyetherimides and polyetherketones. Particularly preferred is polypropylene with a MFI (230° C., 2.16 kg) according to DIN 53735 greater than 20 g/10 min, preferably between 25 and 150 g/10 min. The thermoplastic fibers generally have an average length (weight average) of 20 to 120 mm.

Preferred reinforcing fibers are glass fibers, but carbon fibers (so called “carbon-fibers”), basalt fibers and aramid fibers could also be used, and furthermore natural fibers, e.g. fibers of flax, jute, hemp, kenaf, sisal and cotton. Of particular interest are basalt fibers, which as compared to glass fibers have the advantage of not melting upon the thermal reprocessing of fiber reinforced molded parts and which do not generate any slag. Advantageously, the costly basalt fibers are blended with natural fibers, e.g. in a weight ratio of 10:90 up to 50:50. The reinforcing fibers generally also have an average length (weight average) of 20 to 120 mm. In order to be well miscible with the thermoplastic fibers, they need to be available as individual, non-bound fibers, i.e. they shall not be bound with polymeric binders.

Preferably, the pressing occurs continuously on a double band or calender installation, particularly in succession through a heated and a cooled compression mold in each of which the blended nonwoven is compressed at a pressure of less than 1 bar for at least 3 sec. By varying the pressure during compression, the air pore content, and accordingly also the density of the core layer can be specifically adjusted in the range of 0.1 to 0.6 g/cm³. Such a process is described, e.g., in EP 593 716, WO 02/062563, WO 2005/037897 and WO 2006/05682.

In another process, reinforcing fibers and thermoplastic particles are blended according to the paper manufacturing process, the water is pressed off, the mat is dried and then hot pressed to the semifinished product. Such a process is described, e.g., in U.S. Pat. No. 4,978,489 A.

The layers of the composite sheet are preferably bonded to each other by means of adhesives that are either anhydrous or, at least, of low water content, particularly by means of a foaming one-component polyurethane adhesive or by means of plastic-based hotmelt adhesives such as polyurethanes, modified polyolefins, vinyl acetate, ethylene vinyl acetate (EVA), ethylene acryl acetate (EEA) or by means of film adhesives that are preferably of a foaming type. Appropriate phenolic resin and melamine resin adhesives are also useful. Urea formaldehyde adhesives are used as preferred adhesives. The liquefied or liquid adhesives penetrate into the pores present at the surface of the core layer and thereby form a good mechanical anchoring. The particularly preferred foaming polyurethane adhesives are capable to compensate irregularities of the fiber reinforced core layer so that these cannot manifest themselves through the cover layers at the surface of the composite sheet. Moreover, by using appropriate foaming adhesives in correspondingly precise pressing processes, compliance with the desired thickness tolerance of the composite sheet is achieved.

The cover layers and the core layer are pressed together with the adhesive either discontinuously or also continuously, preferably at temperatures between 0 and 140° C. and pressures between 0.1 and 20 bar. The dimensions of the composite sheets thus obtained can vary in a wide range depending on the application purposes. Their thickness can generally lie between 1.5 and 12 mm. By bonding together several core layers, composite sheets with a thickness of more than 100 mm can be produced.

By varying the thickness of the core layer, the material properties of the composite sheet, e.g. flexural rigidity, flexural modulus of elasticity, shear strength and compressive strength, can be adjusted under a constant thickness.

An interesting application of the composite sheets of the present invention is laminate floorings. In conventional laminate floor boards, the core consists of pressed wood fibers (“High Density Fiberboard”, HDF), and the cover layers consist of HPL sheets. In such instances the floor boards are preferably joined to each other at their front and longitudinal sides without using adhesive. During use, e.g. upon cleaning or due to atmospheric influence, moisture can penetrate into the interstices, which can lead to swelling of the peripheral regions of the floor after some time. Due to such swelling, the optical and handling properties of the floor are affected adversely. This problem does not arise with the composite sheet of the present invention. Because the core layer is not moisture-sensitive, no swelling can occur, so that durability of the floor is significantly extended. Therefore, the composite sheet of the present invention has a high dimensional stability under exposure to moisture. Moreover, the weight saving achieved with the lighter core layer plays an important role, e.g. for the transport and the handling.

Advantageously, the core layer B is provided with peripheral fastening means in order to be connected with the core layer of a further composite sheet. Such systems are generally known and are used, for example, for connecting floor boards without an adhesive. They comprise, for example, mutually engaging elements (milled protrusions+corresponding recesses) or groove/spring or free spring systems suitable for gluing.

Further application fields are ping-pong boards, parts for outdoor furniture and linings, e.g. balcony balustrades.

By virtue of the fact that the cover layers of HPL laminate sheets allow for a large variety of surface design and structuring of the composite sheet according to the present invention, a multitude of decorative surface designs can be realized.

1.-8. (canceled)

9. A composite sheet comprising two cover layers A and a core layer B arranged therebetween, wherein each cover layer A comprises a high pressure laminate (HPL) sheet and wherein the core layer B and the cover layers A are bonded to each other by an anhydrous adhesive, wherein the core layer B comprises a fiber reinforced thermoplastic with a content of reinforcing fibers of 35 to 80 wt-% and a content of air pores of 20 to 85 vol-%, and the adhesive is mechanically anchored in the pores present at the surface of the core layer.

10. The composite sheet of claim 9, wherein the HPL sheet comprises a plurality of cellulose fiber tissue sheets stacked on each other and impregnated with a resin, the HPL sheets having a density of at least 1.4 g/cm³.

11. The composite sheet of claim 9, wherein the thermoplastic is polypropylene and the reinforcing fibers are glass fibers.

12. The composite sheet of claim 10, wherein the thermoplastic is polypropylene and the reinforcing fibers are glass fibers.

13. The composite sheet of claim 9, wherein the cover layers have a thickness of 0.5 to 2.0 mm and the core layer has a thickness of 1 to 10 mm.

14. The composite sheet of claim 10, wherein the cover layers have a thickness of 0.5 to 2.0 mm and the core layer has a thickness of 1 to 10 mm.

15. The composite sheet of claim 11, wherein the cover layers have a thickness of 0.5 to 2.0 mm and the core layer has a thickness of 1 to 10 mm.

16. The composite sheet of claim 12, wherein the cover layers have a thickness of 0.5 to 2.0 mm and the core layer has a thickness of 1 to 10 mm.

17. The composite sheet of claim 9, wherein the adhesive is a foaming one-component polyurethane adhesive, a polymer hotmelt adhesive, a phenolic resin or melamine resin adhesive or a urea formaldehyde adhesive.

18. The composite sheet of claim 10, wherein the adhesive is a foaming one-component polyurethane adhesive, a polymer hotmelt adhesive, a phenolic resin or melamine resin adhesive or a urea formaldehyde adhesive.

19. The composite sheet of claim 11, wherein the adhesive is a foaming one-component polyurethane adhesive, a polymer hotmelt adhesive, a phenolic resin or melamine resin adhesive or a urea formaldehyde adhesive.

20. The composite sheet of claim 13, wherein the adhesive is a foaming one-component polyurethane adhesive, a polymer hotmelt adhesive, a phenolic resin or melamine resin adhesive or a urea formaldehyde adhesive.

21. The composite sheet of claim 9, wherein the core layer B is provided with peripheral fasteners for connecting with the core layer of a further adjoining composite sheet.

22. A method of producing a composite sheet of claim 9, comprising pressing the cover layers and core layer(s) together with the adhesive discontinuously at temperatures between 0 and 140° C. at pressures between 0.1 and 20 bar.

23. The composite sheet of claim 9 which is a laminate flooring product.
